(19) United States
(12) Patent Application Publication
(10) Pub. No.: US 2017/0170512 A1
(43) Pub. Date: Jun. 15, 2017

(54) ELECTROCHEMICAL DEVICE

(71) Applicant: LG CHEM, LTD., Seoul (KR)

(72) Inventors: Jooyong Song, Daejeon (KR); MinHee Lee, Daejeon (KR); Jihyun Kim, Daejeon (KR)

(73) Assignee: LG Chem, Ltd., Seoul (KR)

(21) Appl. No.: 15/024,935

(22) PCT Filed: Feb. 10, 2015
(86) PCT No.: PCT/KR2015/001352

§ 371 Date: Mar. 25, 2016

(30) Foreign Application Priority Data
Feb. 10, 2014 (KR) 10-2014-0014838
Feb. 10, 2014 (KR) 10-2014-0014862

(51) Int. Cl. H01M 10/0525; H01M 10/058

(52) U.S. Cl. CPC H01M 10/0525; H01M 10/058; H01M 10/049

(57) ABSTRACT

The electrochemical device of the present invention comprises: a case; an electrode assembly positioned within the case, the electrode assembly comprising a positive electrode, a negative electrode and a separator interposed between the positive electrode and the negative electrode; an electrolyte which is injected into the case, wherein the volume EV of a free space calculated from Equation 2 is 0-45 volume % with respect to the entire volume CV of an empty space within the case calculated from Equation 1. The contents of Equations 1 and 2 are as set forth in the description. The electrochemical device can solve the problem of gases produced by an oxidation reaction of the electrolyte due to high voltage leading to a reduction in reaction areas on the surfaces of the electrodes and to an increase in side reactions, resulting in accelerated deterioration of capacity.

### TECHNICAL FIELD

The present invention relates to an electrochemical device, and more particularly to an electrochemical device capable of solving problems of gases produced by oxidation of an electrolyte due to high voltage, for example, reducing a reaction area on surfaces of electrodes and promoting an increase in side reactions, resulting in accelerated capacity deterioration.

### BACKGROUND ART

Rechargeable lithium secondary batteries (e.g., lithium ion batteries), nickel-hydrogen batteries, and other secondary batteries have been recognized to be of growing importance as vehicle-mounted power sources, or power sources for portable terminals such as laptop computers. In particular, rechargeable lithium secondary batteries, which are lightweight and may have a high energy density, may be desirably used as high-output power sources for vehicles, and thus demand for rechargeable lithium secondary batteries is expected to increase in the future.

However, as the high-output rechargeable lithium secondary batteries operate at a high voltage, a large amount of gases may be produced due to oxidation of the electrolyte. To solve problems regarding battery swelling due to the produced gases, U.S. Pat. No. 7,223,502 proposes technology of reducing gas production using an electrolyte including a sulfonic compound and a carbonic ester having an unsaturated bond.

In addition, Korean Unexamined Patent Publication No. 2011-0083970 discloses technology in which an electrolyte, which includes a compound containing difluorotoluene having a low oxidation potential, is used to improve a situation in which the electrolyte is decomposed under a high-voltage condition, resulting in battery swelling.

Meanwhile, Korean Registered Patent No. 0760763 discloses an electrolyte for high-voltage rechargeable lithium secondary batteries. Here, decomposition of the electrolyte, which includes halogenated biphenyl and dihalogenated toluene as additives having an oxidation potential of 4.6 to 5.0 V, may be prevented when the electrolyte is used to ensure stability upon overcharging of the rechargeable lithium secondary battery.

In addition, Japanese Unexamined Patent Publication No. 2005-135906 discloses a rechargeable lithium secondary battery including a non-aqueous electrolyte having excellent charge/discharge characteristics. Here, an overcharge inhibitor is added to stably maintain battery performance at a high voltage.

However, such technology has a drawback in that there is no recognition of problems of gases produced by oxidation of an electrolyte due to high voltage, for example, reducing a reaction area on surfaces of electrodes and promoting an increase in side reactions, resulting in accelerated capacity deterioration, and thus offers no solution to such problems.

### PRIOR-ART DOCUMENT

### Patent Document

U.S. Pat. No. 7,223,502 (registered on May 29, 2007)

Korean Unexamined Patent Publication No. 2011-0083970 (published on Jul. 21, 2011)

Korean Registered Patent No. 0760763 (registered on Sep. 14, 2007)

Japanese Unexamined Patent Publication No. 2005-135906 (published on May 26, 2005)

### DISCLOSURE

### Technical Problem

Therefore, the present invention has been made in view of the above problems, and it is an object of the present invention to provide an electrochemical device capable of solving problems of gases produced by oxidation of an electrolyte due to high voltage, for example, reducing a reaction area on surfaces of electrodes and promoting an increase in side reactions, resulting in accelerated capacity deterioration.

### Technical Solution

In accordance with an aspect of the present invention, the above and other objects can be accomplished by the provision of an electrochemical device which includes a case, an electrode assembly positioned inside the case and including a positive electrode, a negative electrode, and a separator interposed between the positive electrode and the negative electrode, and an electrolyte injected into the case, wherein a volume EV of a free space calculated by the following Equation 2 with respect to the entire volume CV of an empty space in the case calculated by the following Equation 1 is in a range of 0 to 45% by volume 1.

Volume CV of empty space in case=Entire volume AV of space in case−Volume BV of electrode assembly [Equation 1]

Volume EV of free space=Volume CV of empty space in case−Volume DV of electrolyte [Equation 2]

The volume EV of the free space with respect to the entire volume CV of the empty space in the case may be in a range of 5 to 30% by volume.

The volume DV of the electrolyte with respect to the entire volume CV of the empty space in the case may be in a range of 55 to 100% by volume.

The volume DV of the electrolyte may be in a range of 0.5 to 10 cm³.

The pressure in the case when the volume EV of the free space is in a range of 0 to 45% by volume may be 1.5 to 15 times the pressure in the case when the volume EV of the free space is greater than 45% by volume in a state in which one cycle, in which the electrochemical device is charged and discharged at a current density of 1 C and a temperature of 25° C., is repeatedly performed for 100 cycles.

The pressure in the case may be in a range of 1 to 15 atmospheres (atm.) in a state in which one cycle, in which the electrochemical device is charged and discharged at a current density of 1 C and a temperature of 25° C., is repeatedly performed for 100 cycles.

The positive electrode may include at least one positive active material selected from the group consisting of LiNi_{1-y}Mn_{y}O₂ (O<y<1), LiMn_{2-z}Ni_{z}O₄ (0<z<2), and a mixture thereof.

The negative electrode may include at least one negative active material selected from the group consisting of synthetic graphite, natural graphite, graphitized carbon fiber, amorphous carbon, and a mixture thereof.

The electrochemical device may be an electrochemical device having a high voltage of 3 V or more.

The electrochemical device may be a rechargeable lithium secondary battery.

In accordance with another aspect of the present invention, there is provided an electrochemical device which includes a case, an electrode assembly positioned inside the case and including a positive electrode, a negative electrode, and a separator interposed between the positive electrode and the negative electrode, and an electrolyte injected into the case, wherein a volume GV of gases, which are produced in the electrochemical device and kept at 25° C. and 1 atm., is 1.5 to 15 times a volume EV of a free space calculated by the following Equation 2 in a state in which one cycle, in which the electrochemical device is charged and discharged at a current density of 1 C and a temperature of 25° C., is repeatedly performed for 100 cycles.

Volume CV of empty space in case=Entire volume AV of space in case−Volume BV of electrode assembly [Equation 1]

Volume EV of free space=Volume CV of empty space in case−Volume DV of electrolyte [Equation 2]

The volume EV of a free space calculated by the following Equation 2 with respect to the entire volume CV of an empty space in the case calculated by the following Equation 1 may be in a range of 0 to 45% by volume 1.

The volume EV of the free space with respect to the entire volume CV of the empty space in the case may be in a range of 5 to 30% by volume.

The volume DV of the electrolyte with respect to the entire volume CV of the empty space in the case may be in a range of 55 to 100% by volume.

The volume DV of the electrolyte may be in a range of 0.5 to 10 cm³.

The pressure in the case when volume EV of the free space is in a range of 0 to 45% by volume may be 1.5 to 15 times the pressure in the case when the volume EV of the free space is greater than 45% by volume in a state in which one cycle, in which the electrochemical device is charged and discharged at a current density of 1 C and a temperature of 25° C., is repeatedly performed for 100 cycles.

The pressure in the case may be in a range of 1 to 15 atmospheres (atm.) in a state in which one cycle, in which the electrochemical device is charged and discharged at a current density of 1 C and a temperature of 25° C., is repeatedly performed for 100 cycles.

The positive electrode may include at least one positive active material selected from the group consisting of LiNi_{1-y}Mn_{y}O₂ (0<y<1), LiMn_{2-z}Ni_{z}O₄ (0<z<2), and a mixture thereof.

The negative electrode may include at least one negative active material selected from the group consisting of synthetic graphite, natural graphite, graphitized carbon fiber, amorphous carbon, and a mixture thereof.

### Advantageous Effects

The electrochemical device according to the exemplary embodiments of the present invention can be useful in solving problems of gases produced by oxidation of an electrolyte due to high voltage, for example, reducing a reaction area on surfaces of electrodes and promoting an increase in side reactions, resulting in accelerated capacity deterioration.

### DESCRIPTION OF DRAWINGS

The above and other objects, features and other advantages of the present invention will be more clearly understood from the following detailed description taken in conjunction with the accompanying drawings, in which:

FIG. 1 is an exploded perspective view showing a rechargeable lithium secondary battery according to one exemplary embodiment of the present invention;

FIG. 2 is a diagram schematically showing a process of capacity deterioration caused by gases produced in a conventional rechargeable lithium secondary battery;

FIG. 3 is a diagram illustrating the principle of reducing a capacity deterioration rate according to one exemplary embodiment of the present invention; and

FIG. 4 is a graph illustrating lifespan characteristics of rechargeable lithium secondary batteries manufactured in Example 1 and Comparative Example 1 of the present invention.

### BEST MODE

Hereinafter, preferred embodiments of the present invention will be described in detail with reference to the accompanying drawings so as to enable those skilled in the art to easily embody the present invention. However, it should be understood that the present invention may be embodied in various different forms, but is not limited to the above-described embodiments.

The terminology used herein is for the purpose of describing particular embodiments only and is not intended to be limiting of exemplary embodiments. The singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, components and/or groups thereof, but do not preclude the presence or addition of one or more other features, whole numbers, steps, operations, elements, components and/or groups thereof.

An electrochemical device according to one exemplary embodiment of the present invention includes a case, an electrode assembly positioned inside the case and including a positive electrode, a negative electrode, and a separator interposed between the positive electrode and the negative electrode, and an electrolyte injected into the case.

The electrochemical device includes any elements in which an electrochemical reaction occurs. For example, specific examples of the electrochemical device include all types of primary and secondary batteries, fuel cells, solar cells, or capacitors such as supercapacitors.

Hereinafter, a case in which the electrochemical device is a rechargeable lithium secondary battery will be described in detail. Rechargeable lithium secondary batteries may be classified into lithium ion batteries, lithium ion polymer batteries, and lithium polymer batteries according to types of separators and electrolytes used herein, and may also be classified into cylindrical secondary batteries, square secondary batteries, coin-type secondary batteries, pouch-type secondary batteries, etc. according to the shapes thereof. In addition, the rechargeable lithium secondary batteries may be classified into bulk-type secondary batteries and film-type secondary batteries according to the size thereof.

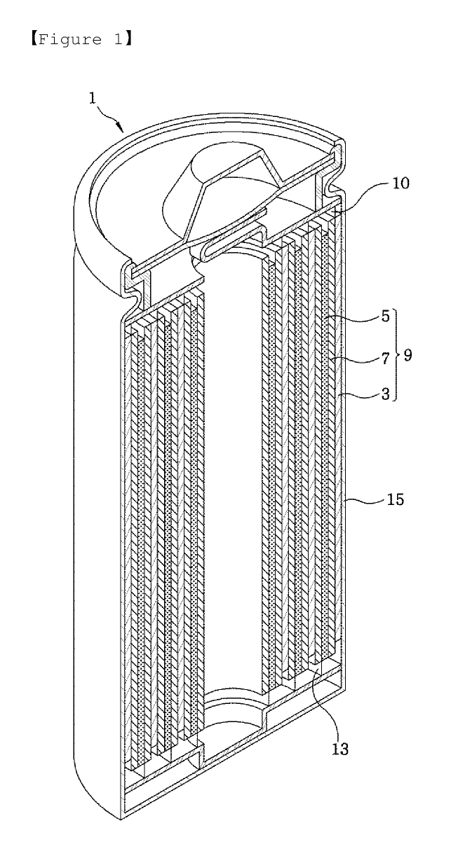

FIG. 1 is an exploded perspective view showing a rechargeable lithium secondary battery 1 according to one exemplary embodiment of the present invention. Referring to FIG. 1, the rechargeable lithium secondary battery 1 may be prepared by arranging a negative electrode 3 and a positive electrode 5, disposing a separator 7 between the negative electrode 3 and the positive electrode 5 to manufacture an electrode assembly 9, positioning the electrode assembly 9 in a case 15, and injecting an electrolyte (not shown) so that the negative electrode 3, the positive electrode 5, and the separator 7 are impregnated with the electrolyte.

Conductive lead members 10 and 13 for collecting current occurring when a battery is operating may be attached to the negative electrode 3 and the positive electrode 5, respectively. The lead members 10 and 13 may conduct current generated from the positive electrode 5 and the negative electrode 3 to positive and negative electrode terminals, respectively.

The negative electrode 3 may be manufactured by mixing a negative active material, a binder, and optionally a conductive material to prepare a composition for forming a negative active material layer, followed by applying the composition to a negative current collector such as copper foil.

A compound in which lithium ions are reversibly intercalatable and deintercalatable (i.e., a lithiated intercalation compound) may be used as the negative active material. Specific examples of the negative active material that may be used herein may include carbonaceous materials such as synthetic graphite, natural graphite, graphitized carbon fiber, amorphous carbon, etc. In addition to such carbonaceous materials, a metallic compound capable of forming an alloy with lithium, or a complex including a metallic compound and a carbonaceous material may also be used as the negative active material.

The metallic compound capable of forming an alloy with lithium that may be used herein may include at least one selected from the group consisting of Si, Al, Sn, Pb, Zn, Bi, In, Mg, Ga, Cd, Si alloy, an Sn alloy, and an Al alloy. In addition, a metal lithium thin film may also be used as the negative active material. Since the negative active material shows high stability, at least one selected from the group consisting of crystalline carbon, amorphous carbon, a carbon complex, a lithium metal, an alloy including lithium, and a mixture thereof may be used as the negative active material.

The binder serves to attach electrode active material particles to each other, and also easily attach an electrode active material to a current collector. Specific examples of the binder that may be used herein may include polyvinylidene fluoride (PVDF), polyvinyl alcohol, carboxymethyl cellulose (CMC), starch, hydroxypropyl cellulose, regenerated cellulose, polyvinyl pyrrolidone, tetrafluoroethylene, polyethylene, polypropylene, an ethylene-propylene-diene polymer (EPDM), sulfonated EPDM, a styrene-butadiene rubber, a fluorine rubber, and various copolymers thereof.

In addition, preferred examples of the solvent may include dimethyl sulfoxide (DMSO), alcohol, N-methylpyrrolidone (NMP), acetone, water, etc.

The current collector may include at least one metal selected from the group consisting of copper, aluminum, stainless steel, titanium, silver, palladium, nickel, and alloys and combinations thereof. In this case, the stainless steel may be surface-treated with carbon, nickel, titanium, or silver, and an aluminum-cadmium alloy may be preferably used as the alloy. In addition, baked carbon, a non-conductive polymer surface-treated with a conductive material, a conductive polymer, or the like may be used.

The conductive material is used to provide conductivity to an electrode, and may include any materials that are electrically conductive without inducing chemical changes in the battery thus configured. Examples of the conductive material that may be used herein may include metal powders and fibers such as natural graphite, synthetic graphite, carbon black, acetylene black, Ketjen black, carbon fiber, copper, nickel, aluminum, silver, etc. In addition, conductive materials such as polyphenylene derivatives may be used alone or in combination of one or more thereof.

As a method of applying the prepared composition for forming a negative active material layer to the current collector, one of known methods may be chosen, or a new proper method may be used in consideration of characteristics of materials, etc. For example, the composition for forming a negative active material layer may be distributed onto the current collector, and then uniformly dispersed using a doctor blade. In some cases, distribution and dispersion processes may be carried out as one process. In addition, methods such as die casting, comma coating, screen printing, etc. may also be used.

Like the negative electrode 3, the positive electrode 5 may be manufactured by mixing a positive active material, a conductive material, and a binder to prepare a composition for forming a positive active material layer, followed by applying the composition for forming a positive active material layer onto a positive current collector such as aluminum foil and rolling the positive current collector. A positive electrode plate may also be manufactured by casting the composition for forming a positive active material layer onto a separate support and then laminating a film obtained through peeling from the support on a metal current collector.

A compound in which lithium ions are reversibly intercalatable and deintercalatable (i.e., a lithiated intercalation compound) may be used as the positive active material. Specifically, a lithium-containing transition metal oxide is preferably used. For example, the positive active material that may be used herein may include at least one selected from group consisting of LiCoO₂, LiNiO₂, LiMnO₂, LiMn₂O₄, Li(NiₐCo_{b}Mn_{c})O₂ (0<a<1, 0<b<1, 0<c<1, and a+b+c=1), LiNi_{1-y}Co_{y}O₂, LiCo_{1-y}Mn_{y}O₂, LiNi_{1-y}Mn_{y}O₂ (O≦y<1), Li(NiₐCo_{b}Mn_{c})O₄ (0<a<2, 0<b<2, 0<c<2, and a+b+c=2), LiMn_{2-z}Ni_{z}O₄, LiMn_{2-z}Co_{z}O₄ (0<z<2), LiCoPO₄, LiFePO₄, and a mixture of two or more thereof. In addition to such oxides, sulfides, selenides, halides, etc. may also be used herein.

The electrolyte may include an organic solvent and a lithium salt.

Any organic solvent may be used as the organic solvent without particular limitation as long as such an organic solvent can serve as a medium through which ions involved in electrochemical reaction of a battery may migrate. Specific examples of the organic solvent that may be used herein may include an ester solvent, an ether solvent, a ketone solvent, an aromatic hydrocarbon solvent, an alkoxy alkane solvent, a carbonate solvent, and the like, which may be used alone or in combination of two or more thereof.

Specific examples of the ester solvent may include methyl acetate, ethyl acetate, n-propyl acetate, dimethyl acetate, methyl propionate, ethyl propionate, γ-butyrolactone, decanolide, γ-valerolactone, mevalonolactone, γ-caprolactone, β-valerolactone, ε-caprolactone, etc.

Specific examples of the ether-based solvent may include dibutyl ether, tetraglyme, 2-methyltetrahydrofuran, tetrahydrofuran, etc.

Specific examples of the ketone-based solvent may include cyclohexanone, etc. Specific examples of the aromatic hydrocarbon-based organic solvent may include benzene, fluorobenzene, chlorobenzene, iodobenzene, toluene, fluorotoluene, xylene, etc. Examples of the alkoxy alkane solvent may include dimethoxy ethane, diethoxy ethane, etc.

Specific examples of the carbonate solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethyl methyl carbonate (EMC), ethylene carbonate (EC), propylene carbonate (PC), butylene carbonate (BC), fluoroethylene carbonate (FEC), etc.

Among such carbonate solvents, a carbonate-based solvent is preferably used as the organic solvent. More preferably, a mixture of a highly dielectric carbonate-based organic solvent, which may have high ionic conductivity to enhance battery charge/discharge performance, and a carbonate-based organic solvent, which may have a low viscosity to properly adjust a viscosity of the high dielectric organic solvent, may be used as the carbonate-based solvent. Specifically, a high dielectric organic solvent selected from the group consisting of ethylene carbonate, propylene carbonate, and a mixture thereof, and a low-viscosity organic solvent selected from the group consisting of ethylmethylcarbonate, dimethylcarbonate, diethylcarbonate, and a mixture thereof may be mixed and used. Most preferably, the high dielectric organic solvent and the low-viscosity organic solvent may be mixed in a volume ratio of 2:8 to 8:2. Specifically, ethylene carbonate or propylene carbonate, ethylmethylcarbonate, and dimethylcarbonate or diethylcarbonate may be mixed in a volume ratio of 5:1:1 to 2:5:3 to be used, and may be preferably mixed in a volume ratio of 3:5:2 to be used.

The lithium salt may be used without particular limitation as long as it is a compound that can provide lithium ions used in the rechargeable lithium secondary battery 1. Specifically, the lithium salt that may be used herein may include at least one selected from the group consisting of LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiN(CₐF₂ₐ₊₁SO₂)(C_{b}F_{2b+1}SO₂) (where a and b are integers, preferably 1≦a≦20 and 1≦b≦20), LiCl, LiI, LiB(C₂O₄)₂, and a mixture thereof. Preferably, lithium hexafluorophosphate (LiPF₆) may be used.

When the lithium salt is dissolved in an electrolyte, the lithium salt functions as a supply source of lithium ions in the lithium secondary battery 1, and may facilitate migration of lithium ions between the positive electrode 5 and the negative electrode 3. Therefore, the lithium salt may be included in a concentration of approximately 0.6 mol % to 2 mol % in the electrolyte. When the concentration of the lithium salt is less than 0.6 mol %, conductivity of the electrolyte may be degraded, resulting in deteriorated electrolyte performance. When the concentration of the lithium salt is greater than 2 mol %, mobility of lithium ions may be reduced due to increase in viscosity of the electrolyte. Accordingly, the concentration of the lithium salt may be particularly adjusted to approximately 0.7 mol % to 1.6 mol % in the electrolyte in consideration of electrolyte conductivity and lithium ion mobility.

In addition to the constituents of the electrolyte, the electrolyte may further include additives (hereinafter referred to as “other additives”) that may be generally used in the electrolyte so as to enhance battery lifespan characteristics, inhibit decrease in battery capacity, and enhance battery discharge capacity.

Specific examples of the other additives may include vinylene carbonate (VC), metal fluoride (for example, LiF, RbF, TiF, AgF, AgF, BaF₂, CaF₂, CdF₂, FeF₂, HgF₂, Hg₂F₂, MnF₂, NiF₂, PbF₂, SnF₂, SrF₂, XeF₂, ZnF₂, AlF₃, BF₃, BiF₃, CeF₃, CrF₃, DyF₃, EuF₃, GaF₃, GdF₃, FeF₃, HoF₃, InF₃, LaF₃, LuF₃, MnF₃, NdF₃, PrF₃, SbF₃, ScF₃, SmF₃, TbF₃, TiF₃, TmF₃, YF₃, YbF₃, TIF₃, CeF₄, GeF₄, HfF₄, SiF₄, SnF₄, TiF₄, VF₄, ZrF4₄, NbF₅, SbF₅, TaF₅, BiF₅, MoF₆, ReF₆, SF₆, WF₆, CoF₂, CoF₃, CrF₂, CsF, ErF₃, PF₃, PbF₃, PbF₄, ThF₄, TaF₅, SeF₆, etc.), glutaronitrile (GN), succinonitrile (SN), adiponitrile (AN), 3,3′-thiodipropionitrile (TPN), vinylethylene carbonate (VEC), fluoroethylene carbonate (FEC), difluoroethylene carbonate, fluorodimethyl carbonate, fluoroethyl methyl carbonate, lithium bis(oxalato)borate (LiBOB), lithium difluoro (oxalate)borate (LiDFOB), lithium (malonato oxalato)borate (LiMOB), etc. which may be used alone or in combination of two or more thereof. The other additives may be included in an amount of 0.1 to 5% by weight, based on the total weight of the electrolyte.

As the separator 7, a conventional porous polymer film used as the separator in the prior art, for example, a porous polymer film manufactured from a polyolefin-based polymer such as an ethylene homopolymer, a propylene homopolymer, an ethylene/butene copolymer, an ethylene/hexene copolymer, and an ethylene/methacrylate copolymer, may be used alone or in a stacked fashion. In addition, typical porous nonwoven fabrics, for example, non-woven fabrics composed of glass fiber having a high melting point or polyethylene terephthalate fiber may be used, but the present invention is not limited thereto.

Meanwhile, in the rechargeable lithium secondary battery 1, the volume EV of a free space calculated by the following Equation 2 with respect to the entire volume CV of an empty space in the case 15 calculated by the following Equation 1 may be in a range of 0 to 45% by volume, preferably 5 to 30% by volume, and most preferably 5 to 25% by volume.

Volume CV of empty space in case=Entire volume AV of space in case−Volume BV of electrode assembly [Equation 1]

Volume EV of free space=Volume CV of empty space in case−Volume DV of electrolyte [Equation 2]

In Equation 1, the volume CV of the empty space in the case 15 refers to a volume equaling the entire volume AV of the space in the case 15 minus a volume BV of the electrode assembly 9 in the case 15, that is, a volume of a space into which an electrolyte may be injected. The volume CV of the empty space in the case 15 may be a volume excluding a volume of a structure taking up a predetermined space in the case 15 as well as the volume BV of the electrode assembly 9. In this case, the volume CV of the empty space in the case 15 may also be a volume excluding a volume of the structure taking up a predetermined space in the case 15. The volume DV of the electrolyte may be calculated based on the amount of an injected electrolyte, but may also be determined by weighing an electrolyte extracted by centrifugation in a prepared battery, or heating a battery to evaporate an electrolyte and converting a difference in weight of the battery before/after heating into a volume of the electrolyte.

The volume EV of the free space refers to a volume equaling the volume CV of the empty space in the case 15 minus the volume DV of the electrolyte, that is, an empty space remaining after injection of the electrolyte.

The volume DV of the electrolyte with respect to the volume CV of the empty space in the case 15 may amount to 55 to 100% by volume, preferably 70 to 95% by volume, and most preferably 75 to 95% by volume. Specifically, the volume DV of the electrolyte may be in a range of 0.5 to 10 cm³.

The rechargeable lithium secondary battery 1 has the volume EV of the free space or the volume EV of the free space as described above, and thus may solve problems of gases produced by oxidation of the electrolyte due to high voltage, for example, reducing a reaction area on surfaces of electrodes and promoting an increase in side reactions, resulting in accelerated capacity deterioration.

Specifically, when a pressure is applied in a state in which the volume of a space is fixed, gases are produced in the space. In this case, the volume of the gases is inversely proportional to the pressure. Assuming that the mass of the produced gases is constant, for example, when 10 ml of the gases are produced at 1 atm., the volume of the gases at 2 atm. is 5 ml. Such a principle is applied to the rechargeable lithium secondary battery 1.

That is, in the case of the rechargeable lithium secondary battery 1, the volume EV of the free space in the case 15 may vary according to the amount of an injected electrolyte. An increase in the amount of the injected electrolyte leads to a decrease in the volume EV of the free space, and a decrease in the amount of the injected electrolyte leads to an increase in the volume EV of the free space.

In addition, even when the electrolyte is injected in an amount such that the positive electrode 5 and the negative electrode 3 are immersed in the electrolyte, performance of the rechargeable lithium secondary battery 1 may be exhibited due to structural characteristics without any problems. Therefore, in the case of the high-voltage rechargeable lithium secondary battery 1, the mass of the gases produced by oxidation of the electrolyte when the electrolyte is injected in an amount such that the positive electrode 5 and the negative electrode 3 are immersed in the electrolyte is identical to the mass of the gases produced when the electrolyte is injected in an amount such that no volume EV of the free space is present.

Therefore, assuming that the mass of the gases produced during a charge/discharge cycle is constant, an increase in the pressure caused by gas production may be slight when the volume EV of the free space is large (i.e., the volume DV of the electrolyte is small). On the other hand, an increase in the pressure caused by gas production may be significant when the volume EV of the free space is small (i.e., the volume DV of the electrolyte is large).

Accordingly, the gases produced by oxidation of the electrolyte due to high voltage may be compressed as the amount of the injected electrolyte increases, resulting in a decrease in volume of the gases. This indicates that a rate at which a reaction area on a surface of the positive electrode 5 or the negative electrode 3 is reduced is lower than that before compression, resulting in a reduction in capacity deterioration rate.

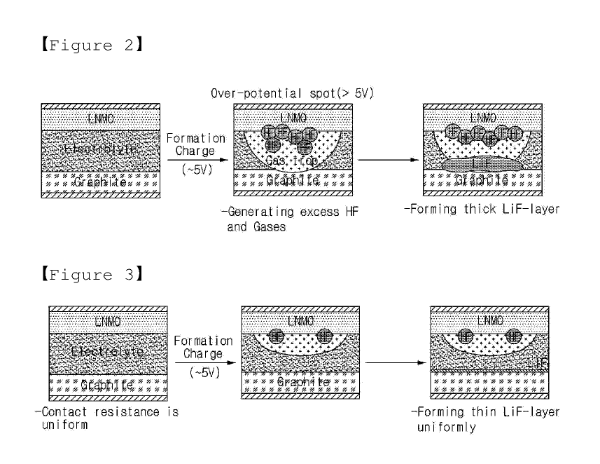

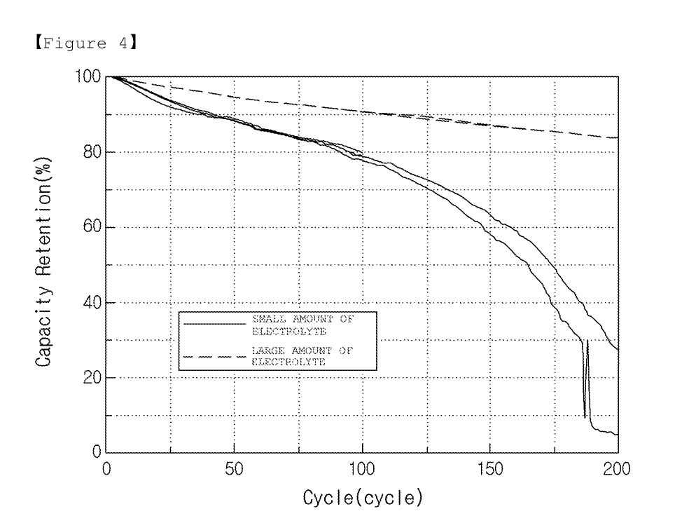

FIG. 2 is a diagram schematically showing a process of capacity deterioration caused by gases produced in a conventional rechargeable lithium secondary battery, and FIG. 3 is a diagram illustrating the principle of reducing a capacity deterioration rate when the volume EV of the free space is small according to one exemplary embodiment of the present invention. In FIGS. 2 and 3, LNMO represents a positive electrode 5, Graphite represents a negative electrode 3, and Electrolyte represents an electrolyte. Referring to FIG. 2, it can be seen that capacity deterioration may occur in the conventional rechargeable lithium secondary battery since a thick, non-uniform surface-coated layer (LiF) is formed on a surface of the negative electrode 3 as HF gas is produced and has an influence on a reaction surface of the negative electrode 3 due to a large volume thereof. On the other hand, referring to FIG. 3, it can be seen that capacity deterioration rate may be reduced since a thin surface-coated layer (LiF) is formed uniformly as the volume EV of the free space is reduced by compression of the produced gas, and thus the gas has no influence on the reaction surface of the negative electrode 3.

In a state in which one cycle, in which the rechargeable lithium secondary battery 1 is charged and discharged at a current density of 1 C and a temperature of 25° C., is repeatedly performed for 100 cycles, the volume GV of gases, which are produced in the rechargeable lithium secondary battery 1 and kept at 25° C. and 1 atm., may be 1.5 to 15 times the volume EV of the free space, preferably 2 to 10 times, and most preferably 3 to 10 times. When the volume GV of the gases, which are kept at 25° C. and 1 atm., with respect to the volume EV of the free space is within this range, the produced gases have no influence on a surface of the negative electrode 3, and thus a thin surface-coated layer (LiF) may be formed uniformly, resulting in a decrease in capacity deterioration rate.

In a state in which one cycle, in which the rechargeable lithium secondary battery 1 is charged and discharged at a current density of 1 C and a temperature of 25° C., is repeatedly performed for 100 cycles, the pressure in the case 15 when the volume EV of the free space is in a range of 0 to 45% by volume may be 1.5 to 15 times, preferably 2 to 12 times, and most preferably 3 to 10 times the pressure in the case 15 when the volume EV of the free space is greater than 45% by volume. That is, when the volume EV of the free space is in a range of 0 to 45% by volume, the produced gases do not influence a surface of the negative electrode 3 as the gases are compressed, and thus a thin surface-coated layer (LiF) may be uniformly formed, resulting in a decrease in capacity deterioration rate.

In a state in which one cycle, in which the rechargeable lithium secondary battery 1 is charged and discharged at a current density of 1 C and a temperature of 25° C., is repeatedly performed for 100 cycles, the pressure in the case 15 may be in a range of 1 to 15 atm., preferably 5 to 15 atm., and more preferably 7 to 15 atm. When the pressure in the case 15 is in this range, the gases produced in the case 15 are compressed, and thus has no influence on a surface of the negative electrode 3. As a result, a thin surface-coated layer may be uniformly formed on the surface of the negative electrode 3, resulting in a decrease in capacity deterioration rate.

The positive electrode 5 may include at least one LNMO-based positive active material selected from the group consisting of LiNi_{1-y}Mn_{y}O₂ (O<y<1), LiMn_{2-z}Ni_{z}O₄ (0<z<2), and a mixture thereof, and the negative electrode 3 may include at least one graphite-based negative active material selected from the group consisting of synthetic graphite, natural graphite, graphitized carbon fiber, amorphous carbon, and a mixture thereof. In addition, the rechargeable lithium secondary battery 1 may be a rechargeable lithium secondary battery 1 having a high voltage of 3V or more, preferably 5V or more. When the positive electrode 5 includes an LMNO-based positive active material, and the negative electrode 3 includes a graphite-based negative active material, the effects of the present invention may be maximized even when the rechargeable lithium secondary battery 1 operates at a high voltage.

Since the rechargeable lithium secondary battery 1 may be manufactured using conventional methods, detailed description of the rechargeable lithium secondary battery 1 is omitted for clarity. By way of example, the cylindrical rechargeable lithium secondary battery 1 has been described in this exemplary embodiment, but the detailed description provided herein is not intended to limit the cylindrical lithium secondary battery 1. For example, secondary batteries having any shapes may be used as long as such secondary batteries can operate as the rechargeable lithium secondary battery.

### MODE FOR INVENTION

### Preparative Example 1: Manufacture of Negative Electrode Using Cathodic Protection

### Example 1

Natural graphite, a carbon black conductive material, and a PVdF binder were mixed in N-methylpyrrolidone as a solvent to prepare a composition for forming a negative active material layer. Therefore, the composition was applied to a copper current collector to form a negative active material layer.

An LNMO positive active material, a carbon black conductive material, and a PVdF binder were mixed in N-methylpyrrolidone as a solvent to prepare a composition for forming a positive active material layer. Thereafter, the composition was applied onto an aluminum current collector to form a positive active material layer.

A separation film made of porous polyethylene was interposed between the above-described positive and graphite-based negative electrodes to manufacture an electrode assembly. Thereafter, the electrode assembly was positioned inside a case, and an electrolyte was injected into the case so that a volume EV of a free space with respect to the entire volume CV of an empty space in the case amounted to 20% by volume, thereby manufacturing a rechargeable lithium secondary battery.

### Comparative Example 1

A rechargeable lithium secondary battery was manufactured in the same manner as in Example 1, except that the electrolyte was injected into the case so that the volume EV of the free space with respect to the entire volume CV of the empty space in the case amounted to 46% by volume.

### Experimental Examples: Measurement of Performance of Manufactured Rechargeable Lithium Secondary Battery

### Experimental Example 1: Measurement of Physical Properties of Manufactured Rechargeable Lithium Secondary Battery

In the case of the rechargeable lithium secondary battery prepared in Example 1, the volume EV of the free space with respect to the entire volume CV of the empty space in the case was 20% by volume, and amounted to 80% by volume, based on the entire volume CV of the empty space in the case. In a state in which one cycle, in which the rechargeable lithium secondary battery was charged and discharged at a current density of 1 C and a temperature of 25° C., was repeatedly performed for 100 cycles, the volume GV of gases, which were produced in the rechargeable lithium secondary battery and kept at 25° C. and 1 atm., was 6 times the volume EV of the free space, and the pressure in the case was 12 atm.

In the case of the rechargeable lithium secondary battery prepared in Comparative Example 1, the volume EV of the free space with respect to the entire volume CV of the empty space in the case was 46% by volume, and amounted to 54% by volume, based on the entire volume CV of the empty space in the case. In a state in which one cycle, in which the rechargeable lithium secondary battery was charged and discharged at a current density of 1 C and a temperature of 25° C., was repeatedly performed for 100 cycles, the volume GV of gases, which were produced in the rechargeable lithium secondary battery and kept at 25° C. and 1 atm., was 12 times the volume EV (i.e., 100 parts by volume) of the free space, and the pressure in the case was 6 atm.

### Experimental Example 2: Measurement of Lifespan Characteristics

Lifespan characteristics of the rechargeable lithium secondary batteries prepared in Example 1 and Comparative Example 1 were measured. A charge/discharge cycle was performed for 200 cycles under charge/discharge conditions of a temperature of 25° C. and a current density of 0.1 C/0.1 C. In this case, each cycle was performed in duplicate. Results are shown in FIG. 4. As shown in FIG. 4, it was revealed that the rechargeable lithium secondary battery of Example 1 had a high electrolyte content, and the rechargeable lithium secondary battery of Comparative Example 1 has a low electrolyte content.

Referring to FIG. 4, it could be seen that the rechargeable lithium secondary battery prepared in Example 1 had improved lifespan characteristics due to decrease in capacity deterioration, compared to the rechargeable lithium secondary battery prepared in Comparative Example 1.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention provides an electrochemical device which includes any elements in which an electrochemical reaction occurs. For example, specific examples of the electrochemical device include all types of primary and secondary batteries, fuel cells, solar cells, or capacitors such as supercapacitors.

1. An electrochemical device comprising:
a case;
an electrode assembly positioned inside the case and comprising a positive electrode, a negative electrode, and a separator interposed between the positive electrode and the negative electrode; and
an electrolyte injected into the case,
wherein a volume EV of a free space calculated by Equation 2 with respect to the entire volume CV of an empty space in the case calculated by Equation 1 is in a range of 0 to 45% by volume,
wherein Equation 1 is as follows:
Volume CV of empty space in case=Entire volume AV of space in case−Volume BV of electrode assembly, and
wherein Equation 2 is as follows:
Volume EV of free space=Volume CV of empty space in case−Volume DV of electrolyte.

2. The electrochemical device according to claim 1, wherein the volume EV of the free space with respect to the entire volume CV of the empty space in the case is in a range of 5 to 30% by volume.

3. The electrochemical device according to claim 1, wherein a volume DV of the electrolyte with respect to the entire volume CV of the empty space in the case is in a range of 55 to 100% by volume.

4. The electrochemical device according to claim 1, wherein the volume DV of the electrolyte is in a range of 0.5 to 10 cm³.

5. The electrochemical device according to claim 1, wherein a pressure in the case when the volume EV of the free space is in a range of 0 to 45% by volume is 1.5 to 15 times a pressure in the case when the volume EV of the free space is greater than 45% by volume in a state in which one cycle, in which the electrochemical device is charged and discharged at a current density of 1 C and a temperature of 25° C., is repeatedly performed for 100 cycles.

6. The electrochemical device according to claim 1, wherein the pressure in the case is in a range of 1 to 15 atmospheres (atm.) in a state in which one cycle, in which the electrochemical device is charged and discharged at a current density of 1 C and a temperature of 25° C., is repeatedly performed for 100 cycles.

7. The electrochemical device according to claim 1, wherein the positive electrode comprises at least one positive active material selected from the group consisting of LiNi_{1-y}Mn_{y}O₂ (O<y<1), LiMn_{2-z}Ni_{z}O₄ (0<z<2), and a mixture thereof.

8. The electrochemical device according to claim 1, wherein the negative electrode comprises at least one negative active material selected from the group consisting of synthetic graphite, natural graphite, graphitized carbon fiber, amorphous carbon, and a mixture thereof.

9. The electrochemical device according to claim 1, wherein the electrochemical device is an electrochemical device having a high voltage of 3 V or more.

10. The electrochemical device according to claim 1, wherein the electrochemical device is a rechargeable lithium secondary battery.

11. An electrochemical device comprising:
a case;
an electrode assembly positioned inside the case and comprising a positive electrode, a negative electrode, and a separator interposed between the positive electrode and the negative electrode; and
an electrolyte injected into the case,
wherein a volume GV of gases, which are produced in the electrochemical device and kept at 25° C. and 1 atm., is 1.5 to 15 times a volume EV of a free space calculated by Equation in a state in which one cycle, in which the electrochemical device is charged and discharged at a current density of 1 C and a temperature of 25° C., is repeatedly performed for 100 cycles,
wherein Equation 2 is as follows:
Volume EV of free space=Volume CV of empty space in case−Volume DV of electrolyte.
